(19) United States
(12) Patent Application Publication
(10) Pub. No.: US 2012/0088179 A1
(43) Pub. Date: Apr. 12, 2012

(54) METHOD OF CLAMPING FUEL CELL STACK

(75) Inventors: Bu Ho Kwak, Yongin (KR); Bo Ki Hong, Seoul (KR); Kook Il Han, Seoul (KR); Ji Yeon Park, Yongin (KR)

(73) Assignee: Hyundai Motor Company, Seoul (KR)

(21) Appl. No.: 12/952,068

(22) Filed: Nov. 22, 2010

(30) Foreign Application Priority Data
Oct. 8, 2010 (KR) 10-2010-0098509

(51) Int. Cl. H01M 8/24

(52) U.S. Cl. 429/470

(57) ABSTRACT

A method of clamping a fuel cell stack includes a stack preliminary clamping step, a stack pre-treatment step of performing a gas flow rate variation cycle or a clamping pressure variation cycle, wherein the gas flow rate variation cycle repeatedly changes a flow rate of a gas supplied to an anode and a cathode included in the preliminarily clamped stack, and wherein the clamping pressure variation cycle repeatedly increases and decreases the clamping pressure by pressurization and pressure release of the preliminarily clamped stack using the pressure tool, and a stack main clamping step of correcting a variation in clamping pressure occurring due to a variation in thickness of a gas diffusion layer to mainly clamp the stack after the stack pre-treatment step.

### CROSS-REFERENCE TO RELATED APPLICATION

This application claims the benefit of Korean Patent Application No. 10-2010-0098509, filed on Oct. 8, 2010, under 35 U.S.C. §119(a). The entire contents of the aforementioned application are incorporated herein by reference.

### BACKGROUND

(a) Technical Field

The present disclosure is directed to a method of clamping a fuel cell stack, and more specifically, to a method of clamping a fuel cell stack that may clamp the stack in a stable and optimal manner without any problems, such as an irreversible variation in thickness of a gas diffusion layer, a lowering in clamping pressure, creation of a tiny gap, an increase in contact resistance, etc., while the stack is operated.

(b) Background Art

A fuel cell is an energy converting device that converts the chemical energy of a source fuel into electric energy through an electrochemical reaction, without a process of converting the source fuel into heat by combustion. Fuel cells may be utilized as power sources for vehicles and other industrial and domestic purposes. Also, the fuel cells may be useful to supply power to small electric/electronic devices, portable devices, etc.

Currently, polymer electrolyte membrane fuel cells (“PEMFCs”) having high power density are most broadly researched as fuel cells for vehicles.

A PEMFC is operated at a relatively low temperature on the order of 50˜100° C., and offers the following advantages over other types of fuel cells: a rapid startup time, power converting reaction time, and high energy density.

A fuel cell stack includes a membrane-electrode assembly (“MEA”) as a main component. The MEA is positioned in the inside of a stack and includes a solid high molecular electrolyte membrane that may move hydrogen ions, and electrode layers at both surfaces of the electrolyte membrane. The electrode layers include a cathode and an anode that are applied with a catalyst to react with oxygen and hydrogen.

Further, a gas diffusion layer (“GDL”) and a gasket are disposed on an outer portion of the MEA, where the cathode and anode are positioned. A bipolar plate is disposed on an outer portion of the gas diffusion layer. The bipolar plate includes a flow field for the supply of a reaction gas (hydrogen as a fuel and oxygen or air as an oxidant). Also, cooling water may pass through the flow field.

The above construction forms a unit cell. A plurality of unit cells are stacked on one another and end plates are joined on the outmost portion thereof, thus completing a fuel cell stack.

An operation principle of a PEMFC will now be described. Hydrogen, which is a fuel source, and oxygen (air), which is an oxidant, are supplied to the anode and cathode, respectively, of the MEA. Through the flow field of the bipolar plate, hydrogen supplied to the anode that is an oxidation electrode is dissolved into hydrogen ions (proton, H⁺) and electrons (e⁻) by the catalyst applied on the electrode layer.

The hydrogen ions only penetrate the electrolyte membrane that is a cation exchange membrane, and are transferred to the cathode. Simultaneously, the electrons are transferred to the cathode through the gas diffusion layer and bipolar plate that is a conductor, and an external lead. The flow of electrons through the external lead becomes an electric current.

At the cathode (a reduction electrode), the hydrogen ions transferred through the electrolyte membrane and the electrons transferred through the bipolar plate react with oxygen supplied to the cathode to generate water and heat.

Each unit cell only generates a low voltage. Accordingly, a few tens of or a few hundreds of unit cells are stacked on one another to form a fuel cell stack in order to generate a high voltage. A general structure of the fuel cell stack is shown in FIG. 1.

A conventional method of assembling and clamping a fuel cell stack includes a bolt clamping method, a band clamping method, and a wire clamping method. In the bolt clamping method, end plates 120 and 121 are joined on both ends of stacked cells 110, and are then pressurized by a pressure tool. Then, long bolts (clamping rods) 130 are inserted through the end plates 120 and 121 and are fastened by nuts 140 so that the end plates 120 and 121 are not moved.

In the band clamping method, end plates are joined on both ends of the stacked cells, and are then pressurized by a press. Under this situation, the end plates are tied by a band, which is in turn fastened to the end plates by a bolt.

The end plates play a role to support and pressurize the bipolar plate. The end plates are fastened by a material, such as bolts and nuts, bands, or wires, with a constant surface pressure maintained over the entire area of the bipolar plate. By doing so, stack clamping is complete.

After stack clamping, the end plates are kept to attract each other, and the band or wire maintains a constant length. In this case, the surface pressure between two neighboring cells has a considerable effect on the overall output of the fuel cell stack. The surface pressure in the stack is directly associated with mass transfer resistance in the gas diffusion layer and ohmic loss due to an increase in contact resistance. Accordingly, for good performance of the stack it is necessary to properly maintain a clamping force.

In a case where the surface pressure is too low, a contact resistance is increased between the bipolar plate, the gas diffusion layer, and the MEA, and thus, a current-voltage drop occurs. In a case where the surface pressure is too high, the gas diffusion layer is excessively compressed making it difficult to diffuse a gas. As a result, a stack output is lowered.

For vehicles using a fuel cell, it is important to effectively clamp the stack in order to raise a stack performance and reduce the weight and volume of the stack. Further, it is necessary to exactly understand the physical properties of components included in the stack.

For this purpose, a number of stack clamping methods and component evaluation methods have been conventionally suggested, and include stack clamping-related inventions, a fuel cell stack clamping apparatus (Korean Patent No. 0514375), a fuel cell stack fastener (Korean Patent Application Publication No. 2010-20715), a fuel cell stack clamping structure (Korean Patent No. 501206); stack assembling/activating-related inventions, a fuel cell stack automatic assembling apparatus (Korean Patent Application Publication No. 2009-106217), a stack airtight seal testing apparatus and method (Korean Patent Application Publication Nos. 2009-113429 and 2009-108478), a fuel cell activation method (Korean Patent Application Publication No 2007-60760); and component property evaluating-related inventions, including an apparatus of positioning a pin hole of an electrolyte membrane (Korean Patent Application Publication No. 2009-107610), an MEA/gas diffusion layer integrated facility (Korean Patent Application Publication No. 2009-111898), a fuel cell bipolar plate airtight seal detecting apparatus (Korean Patent Application Publication No. 2009-113432), an apparatus of measuring thickness/resistance/differential pressure/transmittance of a gas diffusion layer for each pressure (Korean Patent No. 902316), and a gas diffusion layer separation detecting apparatus (Korean Patent Application Publication No. 2009-108767).

As R&D and mass production of PEMFCs for vehicles are currently ongoing, a gas diffusion layer that, among components of the fuel cell stack, plays an important role to obtain a stable performance is broadly researched and developed in terms of its property evaluation method and mechanism for achieving micro structure/performance.

In general, a gas diffusion layer includes a gas diffusion backing layer and a micro porous layer applied on the gas diffusion backing layer. The gas diffusion backing layer is made of a carbon-based material, such as carbon paper, carbon cloth, or carbon felt [Escribano, J. Blachot, J. Etheve, A. Morin, R. Mosdale, J. Power Sources, 156, 8 (2006); M. F. Mathias, J. Roth, J. Fleming, and W. Lehnert, Handbook of Fuel Cells—Fundamentals, Technology and Applications, Vol. 3, Ch. 42, John Wiley & Sons (2003)], or may contain a metallic porous thin film or a porous metallic mesh.

Carbon materials, such as carbon powder, carbon nano rods, carbon nano wires, or carbon nano tubes, conductive metals, inorganic materials, or ceramic powder are used alone or in a combination thereof to manufacture the micro porous layer. The micro porous layer may include a hydrophobic agent, such as polytetrafluoroethylene (“PTFE”) or fluorinatedethylenepropylene (“FEP”) for smooth dehydration, and a hydrophilic agent, such as nafion ionomer, to improve ionic conductivity. The micro porous layer may include a predetermined micro porous structure.

The gas diffusion layer included in the unit cell functions not only as a passage through which a reaction gas and a reaction product pass, i.e., water, but also as a medium where thermal and electrical conduction occurs. Further, the gas diffusion layer discharges the reaction product, water, to minimize an overflow of the water.

Since the thickness and micro structure of the gas diffusion layer is changed during the actual operation, it is necessary to understand a variation in physical properties of the gas diffusion layer that occurs in a clamping state. As can be seen in FIG. 2A, the thickness of the gas diffusion layer varies with clamping pressure. In a case where a decrease in thickness was initiated by a high clamping pressure, the gas diffusion layer experiences an inelastic deformation wherein the thickness does not return to its original state even though the clamping pressure is reduced again.

This phenomenon can also be seen through a shape of a cross section obtained after the gas diffusion layer used for stack clamping is detached. It can be seen in FIG. 3 that a portion of the gas diffusion layer which was in contact with a land portion of the bipolar plate that is subjected to the clamping pressure, remains contracted and deformed although the gas diffusion layer is detached from the stack and no further pressure is exerted to the gas diffusion layer. FIG. 2B illustrates a variation in electric conductivity of the gas diffusion layer depending on a variation in clamping pressure, wherein as the clamping pressure decreases, electric resistance increases in the gas diffusion layer.

In cases where a long bolt or band is used as a conventional structure for clamping a fuel cell stack, the length of the stack remains unchanged after the stack clamping. Accordingly, if a thickness of the gas diffusion layer, which is a component of the stack, is decreased during the operation, a surface pressure distribution is changed in the unit cell, and this makes it difficult for an even pressure to be maintained over the entire area of the stack. Moreover, the output of the fuel cell stack may be reduced.

Accordingly, in a case where the thickness of the gas diffusion layer is changed due to a variation in clamping pressure that is caused by an increase and decrease of vibration or gas flow rate (gas supply flow rate and feed flow rate) during the stack operation, a tiny gap is created between components of the cell as shown in FIG. 4C, resulting in an increase in contact resistance compared to immediately after stack clamping as shown in FIG. 4B. Therefore, it is critical to find an optimal stack clamping condition that may control the above situations.

### SUMMARY OF THE DISCLOSURE

Embodiments of the present invention provide a method of clamping a fuel cell stack that may stably and optimally clamp the stack without any problems, such as an irreversible variation in thickness of a gas diffusion layer, a lowering in clamping pressure, creation of a tiny gap, an increase in contact resistance, etc., while the stack is operated.

According to an embodiment of the present invention, there is provided a method of clamping a fuel cell stack, comprising a stack preliminary clamping step of setting and fastening a fastener to the stack so that a clamping pressure exerted to the stack by a pressure tool is maintained, wherein the stack includes a plurality of unit cells stacked on one another and end plates joined on the stacked unit cells, a stack pre-treatment step of performing a gas flow rate variation cycle or a clamping pressure variation cycle, wherein the gas flow rate variation cycle repeatedly changes a flow rate of a gas supplied to an anode and a cathode included in the preliminarily clamped stack, wherein the clamping pressure variation cycle repeatedly increases and decreases the clamping pressure by pressurization and pressure release of the preliminarily clamped stack using the pressure tool, and a stack main clamping step of correcting a variation in clamping pressure occurring due to a variation in thickness of a gas diffusion layer to mainly clamp the stack after the stack pre-treatment step.

In certain embodiments, the invention provides a method wherein the gas flow rate variation cycle performs flow rate increasing/decreasing steps of the gas supplied to the anode and the cathode, included in the preliminarily clamped stack or gas supply/shut-off steps, to repeatedly cause a flow rate variation.

In various embodiments, the invention provides a method wherein in the gas flow rate variation cycle, a flow rate of the gas supplied during the gas flow rate increasing step or a flow rate of the gas supplied during the gas supply step is set to a predetermined maximum flow rate of a reaction gas required for stack operation, and a flow rate of the gas supplied during the gas flow rate decreasing step is set to a predetermined minimum flow rate of the reaction gas required for stack operation.

In other embodiments, the invention provides a method wherein assuming the gas flow rate increasing/decreasing steps or the gas supply/shut off steps are a basic cycle, the gas flow rate variation cycle repeats two or three basic cycles, and for each basic cycle, each of the gas flow rate increasing/decreasing steps and the gas supply/shut-off steps lasts from about 5 seconds to about 60 minutes.

In certain embodiments, the invention provides a method wherein the gas flow rate variation cycle repeats at least ten basic cycles, and for each basic cycle, each of the gas flow rate increasing/decreasing steps and the gas supply/shut-off steps lasts about 5 seconds to about 60 minutes.

In another embodiment, the invention provides a method, wherein the gas is air or an inert gas.

In still another embodiment, the invention provides a method, wherein the gas flow rate variation cycle is performed by supplying a reaction gas during a stack activation process after the stack preliminary clamping step, and the stack main clamping step is performed after the stack activation process.

In certain embodiments, the invention provides a method wherein a relative humidity of the gas is in a range between about 20% to about 100%, and a temperature of the gas is in a range between about 0° C. to about 95° C.

In another embodiment, the invention provides a method wherein the clamping pressure variation cycle repeatedly pressurizes and depressurizes the end plates by a pressure tool so that an additional pressure is exerted to the gas diffusion layer through a bipolar plate.

In other embodiments, the invention provides a method wherein the stack main clamping step includes exerting the same pressure as the pressure exerted during the stack preliminary clamping step to the stack having the gas diffusion layer, whose thickness has been reduced after the stack pre-treatment step by the pressure tool to correct a decrease in the clamping pressure, and resetting and fastening the fastener so that the clamping pressure is maintained.

In various embodiments, the invention provides a method, further comprising: activating the stack after the stack main clamping step to complete clamping and assembly of the stack.

According to the embodiments of the present invention, the method of clamping a fuel cell stack performs a process of correcting a variation in clamping pressure after the preliminary clamping and pre-treatment process of the stack, and thus, may stably and optimally clamp the stack without any problems, such as an irreversible variation in thickness of a gas diffusion layer, a lowering in clamping pressure, creation of a tiny gap, an increase in contact resistance, etc., while the stack is operated.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention.

FIG. 1 is a perspective view illustrating a structure of a clamped fuel cell stack;

FIGS. 2A and 2B are views illustrating basic physical properties of a gas diffusion layer according to a variation in clamping pressure, wherein FIG. 2A illustrates a variation in thickness of the gas diffusion layer and FIG. 2B illustrates a variation in electric resistance of the gas diffusion layer;

FIG. 3 is a cross section view illustrating a gas diffusion layer after the gas diffusion layer is detached from a stack;

FIGS. 4A, 4B, and 4C are views illustrating a deformation in shape that occurs at a gas diffusion layer of a fuel cell stack, wherein FIG. 4A illustrates a state shown before the fuel cell stack is clamped, FIG. 4B illustrates a state shown right after the fuel cell, stack is clamped, and FIG. 4C illustrates a state shown after the clamping pressure has been repeatedly changed in the stack;

FIG. 5 is a flowchart illustrating methods of clamping a stack according to the first and second embodiments of the present invention;

FIG. 6 a flowchart illustrating a method of clamping a stack according to a third embodiment of the present invention;

FIG. 7 is a view illustrating a method of measuring a variation in clamping pressure of a stack depending on a variation in the amount of a gas passing through a gas diffusion layer;

FIG. 8 is a graph illustrating a relationship between a variation in gas feed flow rate and a variation in stack clamping pressure, which is obtained while the clamping pressure remains unchanged; and

FIG. 9 is a graph illustrating a relationship between a clamping pressure variation cycle of a gas diffusion layer and a thickness of the gas diffusion layer.

### DETAILED DESCRIPTION

Hereinafter, exemplary embodiments of the present invention will be described with reference with the accompanying drawings.

As described above, a few tens to a few hundreds of unit cells are stacked on one another and end plates are joined on the ends thereof. Then, the end plates are clamped by a long bolt (clamping rod), a band, or a wire, so that a uniform pressure is exerted over the entire area of the MEA of each cell.

The bipolar plate, the gasket, and the MEA have high elasticity, and their thickness is reversibly changed with the clamping pressure. However, the gas diffusion layer is mainly made of a porous carbon support for purposes of smooth diffusion of a reaction gas and dehydration. Accordingly, the gas diffusion layer experiences an irreversible change in thickness depending on a variation in clamping pressure.

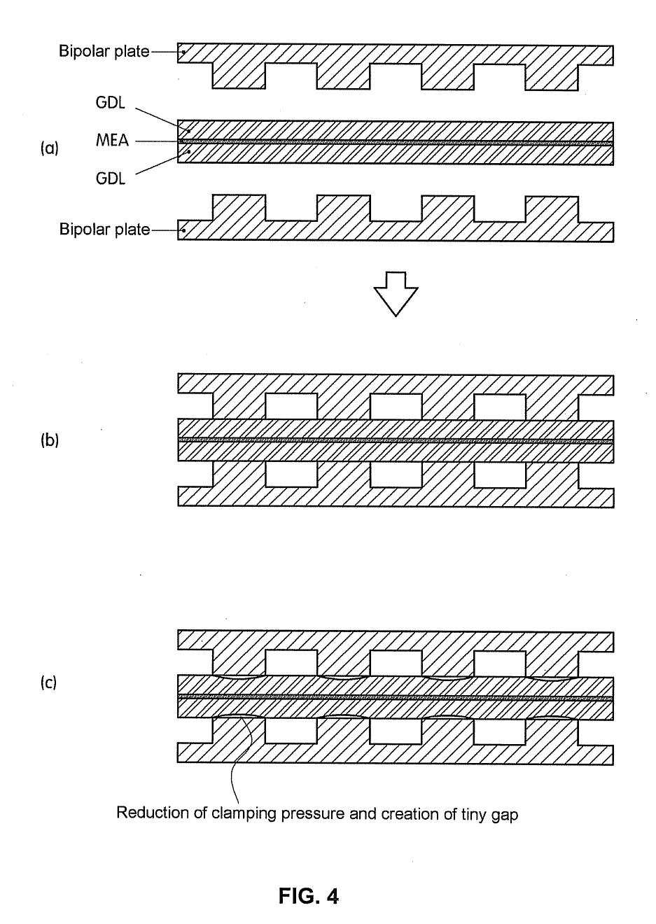

Thus, if the clamping pressure is changed due to vibration occurring during the stack operation, with the stack size remaining unchanged by the long bolt, band, or wire after the stack clamping, then the thickness of the gas diffusion layer is further decreased. Because the thickness of the gas diffusion layer is irreversibly changed, the gas diffusion layer does not return to its original thickness. As a result, a tiny gap may be created between the gas diffusion layer and the bipolar plate as shown in FIG. 4C. Therefore, contact resistance between components of the cell may be increased and a surface pressure may be non-uniformly distributed, thus decreasing a stack performance.

To solve the above problem, an embodiment of the present invention provides a method of clamping a PEMFC stack, which sequentially performs a pre-treatment process of inducing a variation in thickness of the gas diffusion layer, with the stack preliminarily clamped, a process of correcting a variation in clamping pressure caused by the thickness change of the gas diffusion layer that occurs during the pre-treatment process, and a main clamping process.

According to the embodiments of the present invention, the method of clamping a fuel cell stack performs a process of correcting a variation in clamping pressure after the preliminary clamping and pre-treatment process of the stack, and thus, may stably and optimally clamp the stack without any problems, such as an irreversible variation in thickness of a gas diffusion layer, a lowering in clamping pressure, creation of a tiny gap, an increase in contact resistance, etc., while the stack is operated.

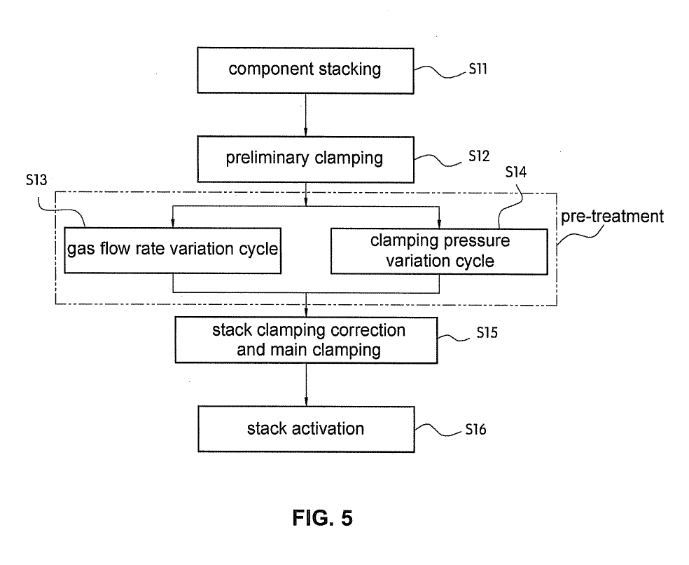

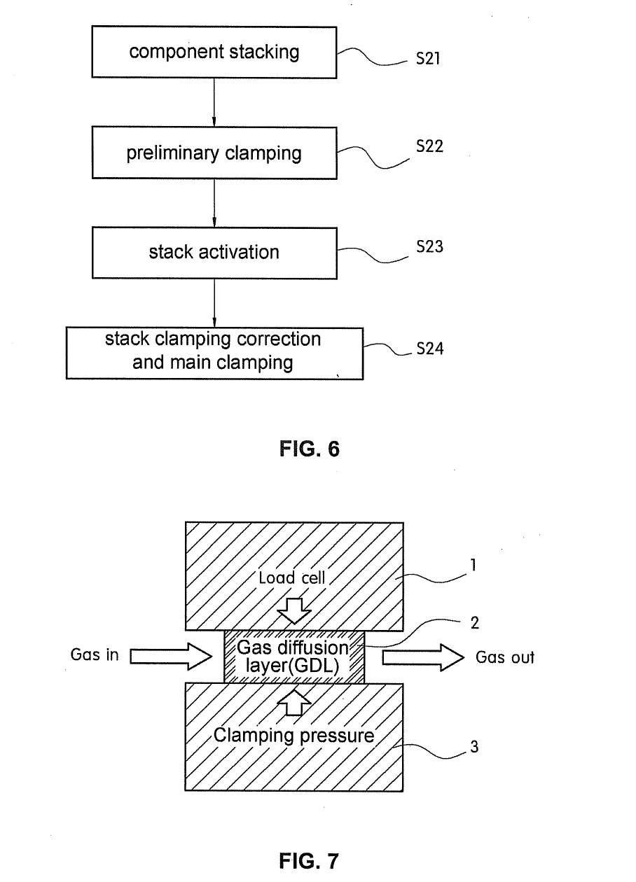

FIG. 5 is a flowchart illustrating a stack clamping method according to a first embodiment and a second embodiment of the present invention, and FIG. 6 is a flowchart illustrating a stack clamping method according to a third embodiment of the present invention.

The first embodiment includes steps. S11 to S13, S15, and S16 of FIG. 5, and the second embodiment includes steps S11 and S12, and S14 to S16.

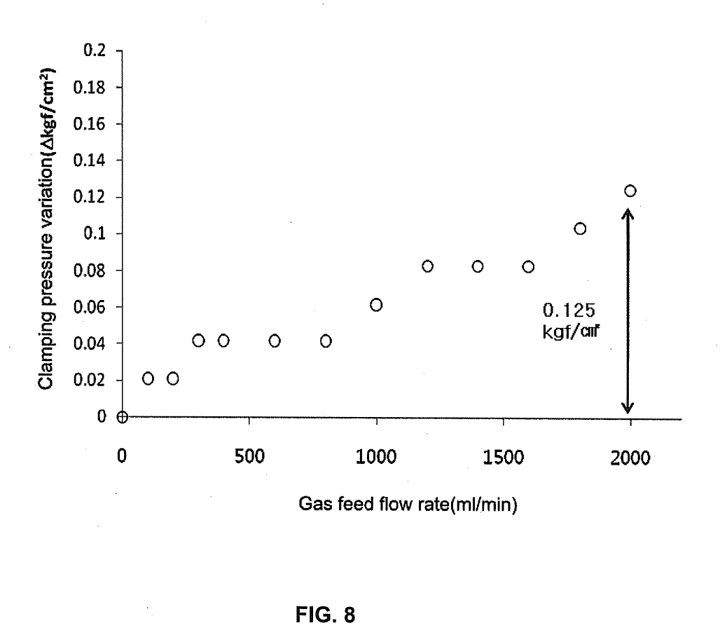

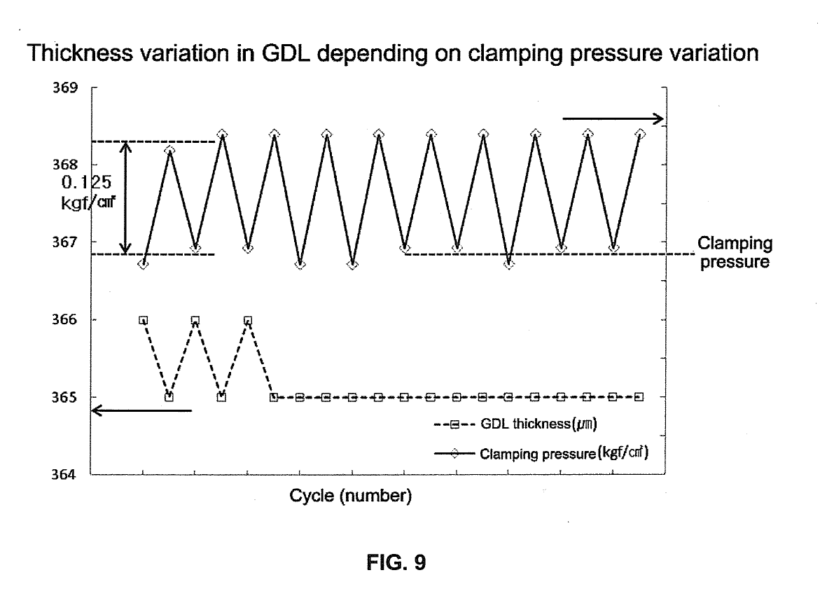

FIG. 7 is a view illustrating a method of measuring a variation in clamping pressure of a stack depending on a variation in the amount of a gas passing through a gas diffusion layer, FIG. 8 is a graph illustrating a relationship between a variation in gas feed flow rate and a variation in stack clamping pressure, which is obtained while the clamping pressure remains unchanged, and FIG. 9 is a graph illustrating a relationship between a clamping pressure variation cycle of a gas diffusion layer and a thickness of the gas diffusion layer.

As can be seen from the experiment results shown in FIGS. 8 and 9, an increase/decrease of the flow rate of a reaction gas supplied into a stack causes a tiny change in the clamping pressure for each unit cell. Such change in clamping pressure changes the thickness of a gas diffusion layer in the stack. As the clamping pressure increases, the thickness of the gas diffusion layer decreases.

It can be also seen that a change in thickness of the gas diffusion layer depending on a change in clamping pressure, appears early during a few cycles (gas flow rate variation cycle) and then becomes stable without any change in thickness (See FIGS. 8 and 9).

The embodiment of the present invention utilizes the above principle. That is, before the stack is completely clamped, a pre-treatment process is first performed that induces the clamping pressure and resultant thickness change of the gas diffusion layer during the stack clamping over a few cycles, and then, while there is no change in thickness, the stack clamping pressure variation and the thickness variation are corrected, so that, during the actual stack operation, the following problems do not occur: irreversible thickness variation in the gas diffusion layer, lowering in clamping pressure, creation of a tiny gap, or increase in contact resistance.

According to an embodiment, the pre-treatment process may be achieved by performing a gas flow rate variation cycle (the first embodiment-gas flow rate increasing/decreasing step or gas supply/shut-off step) and a clamping pressure variation cycle (second embodiment-increase and decrease of clamping pressure using a pressure tool for clamping) after the stack is preliminary clamped. Here, the gas flow rate variation cycle after the preliminary clamping of the stack may be carried out in a usual stack activation process after the stack is clamped (third embodiment-using a change in gas flow rate in the stack activation process).

Hereinafter, the embodiments of the present invention will be described in greater detail.

According to the first embodiment, as shown in FIG. 5, end plates are joined on both ends of a stack having unit cells stacked (S11). Then, a predetermined clamping pressure is exerted to the stack through the end plates by using a pressure tool for clamping the stack, and a fastener is set and fastened to the stack to maintain the clamping pressure, so that the stack is preliminary clamped (S12).

In this case, the preliminary clamping of the stack is done at a clamping pressure that may provide an airtight seal for cathode/anode flow fields and cooling water flow field. At this time, the fastener is set to make the size of the stack unchanged. The preliminary clamping process, the pre-treatment process, and the main clamping processes are part of a process of producing a stack according to an embodiment. Accordingly, existing tools, such as a press, that may control a pressurizing force may be utilized as the fastener without any change. Also, well-known clamping means, such as bolts, bands, wires, etc., may be utilized as the fastener without any change.

Further, the clamping pressure for preliminary clamping may be a common clamping pressure used in an existing stack assembling process since an airtight seal needs to be maintained in the flow fields of the stack.

After the preliminary clamping process is complete, a gas flow rate variation cycle is performed as a pre-treatment process for the gas diffusion layer by increasing/decreasing the flow rate of the gas introduced into the stack or intermittently supplying the gas into the stack at a predetermined cycle (that is, by repeatedly supplying the gas and shutting off the gas supply) (S13).

In this process, the gas is simultaneously supplied into both the cathode and anode of the stack. The thickness of the gas diffusion layer gradually varies due to the repeated change in the flow rate occurring during the gas supply. However, after the predetermined cycle is lapsed, a further change in thickness does not occur in spite of continuous change in flow rate. This state is called “stable state”.

After the pre-treatment process repeatedly changing the gas flow rate, the thickness of the gas diffusion layer is slightly reduced, so that the clamping pressure is lowered compared to the clamping pressure right after the preliminary clamping process and prior to the pre-treatment process, and a tiny gap is created between the gas diffusion layer and a bipolar plate.

After the thickness of the gas diffusion layer reaches the stable state, the clamping pressure variation is corrected over the entire stack to get rid of the tiny gap that occurs due to a lowering of the clamping pressure, and then the main clamping process is performed (S15). Thereafter, a usual stack activation process is performed (S16) to complete clamping and assembling of the stack.

Specifically, the stack clamping pressure is adjusted as much as the variation. Such adjustment may be performed by mounting and pressurizing the stack once again to be subjected to the same clamping pressure as that used in the preliminary clamping process after the pre-treatment process that repeatedly changes the flow rate of supplied gas (i.e., increase/decrease of the flow rate or supply/shut-off of the gas). Under such pressurized condition, the main clamping process is performed by setting and fastening the fastener again so that the clamping pressure and the stack size (which means a distance between both the end plates of the stack) may be constant over the entire stack.

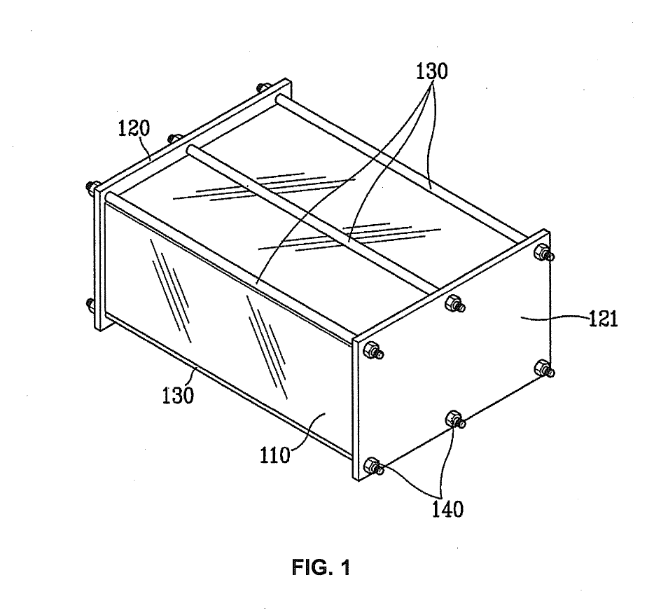

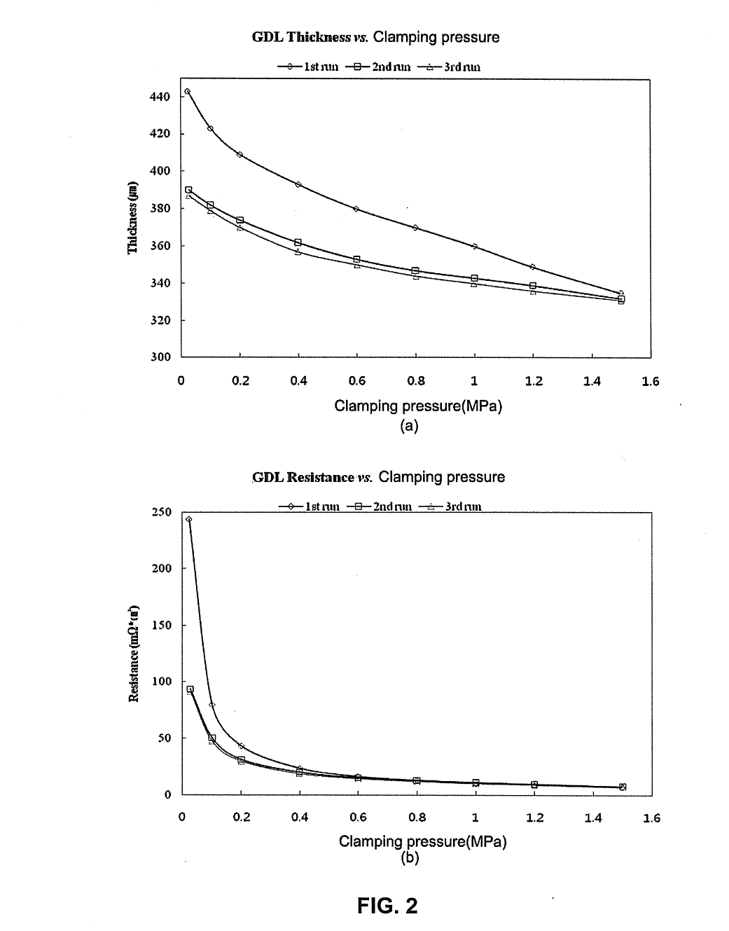

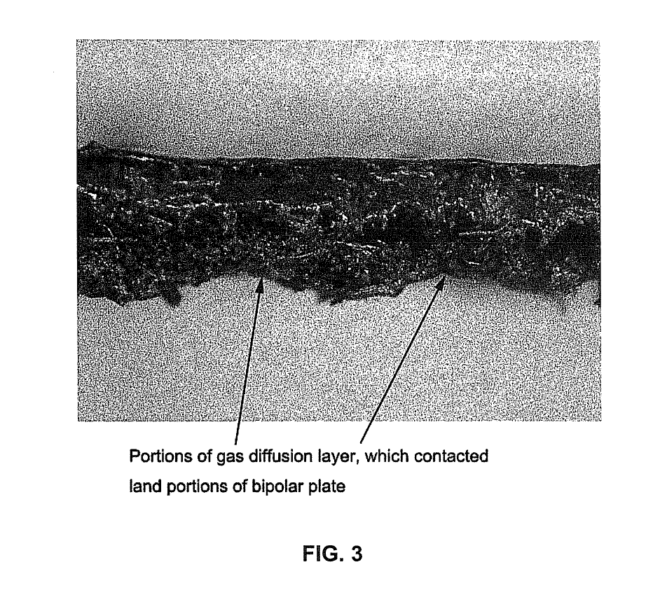

Assuming a bolt as shown in FIG. 1 is used in the clamping pressure variation correcting process and main clamping process, a nut may be slightly fastened so that the stack size may completely remain unchanged while substantially the same clamping pressure as that used in the preliminary clamping process is exerted to the stack by the pressure tool.

In the case of using a band or wire, the tension of the band or wire may be finely adjusted so that the stack size may completely remain unchanged while substantially the same clamping pressure as that used in the preliminary clamping process is exerted to the stack by the pressure tool.

Upon correction of the clamping pressure variation, excessive pressure may cause an additional thickness decrease in the gas diffusion layer. Therefore, a clamping pressure during the preliminary clamping process may be set to be equal to a clamping pressure during the main clamping process, which is the same as a clamping pressure during the stack operation. Further, a pressurized state (clamping pressure state) during the correction and main clamping process after the pre-treatment process may be set to be equal to a pressurized state during the preliminary clamping process.

The gas employed for the gas flow rate variation cycle may include air or inert gases, such as nitrogen. Further, humidity and temperature of the gas may be in a range of 20-100% and 0-95° C., respectively. In cases where the relative humidity of the gas is less than 20%, the membrane-electrode assembly (“MEA”) is excessively dried and thus may be broken or deformed. In cases where the relative humidity of the gas is in excess of 100%, more energy than necessary may be required to maintain humidity during the flow rate variation cycle, and it may be difficult to manage water due to flooding in the stack. Further, in cases where the temperature of the gas is less than 0° C., an inner portion of the stack may be frozen due to the humidity. In cases where the temperature of the gas exceeds 95° C., the MEA may be damaged due to the increased temperature and energy consumption may be unnecessarily increased.

There is no limitation in the flow rate of the gas supplied during the gas flow rate variation cycle. For example, the flow rate of the gas supplied during the gas flow rate increasing step or gas supply step may be a predetermined maximum flow rate of a reaction gas, which is required when a stack to be clamped operates normally.

Further, the flow rate of the gas supplied during the gas flow rate decreasing step may be a predetermined minimum flow rate of the reaction gas, which is required when the stack operates normally.

There is no specific limit on the number of cycles. For example, considering the efficiency of manufacturing processes, two or three cycles may be repeated until the gas diffusion layer has a stable thickness. According to an embodiment, taking into consideration that the gas diffusion layer has different physical properties according to manufacturers, at least ten cycles may be repeated. Further, each of gas flow rate increasing/decreasing steps and gas supply/shut-off steps may be maintained for 5 seconds to 60 minutes.

The reason why two or three cycles are performed is that the thickness of the gas diffusion layer may be stabilized by doing so, as can be seen from the experiment results shown in FIG. 9.

However, too many repetitions of cycle may delay the stack manufacturing processes and increase the gas consumption, and results in decreased productivity and economy.

Further, a commercially available gas diffusion layer may have different physical properties depending on the material. Considering this, at least ten or more times of cycle may be repeated until the gas diffusion layer is stabilized. By doing so, the thickness of the gas diffusion layer may be sufficiently stabilized. Further, as the number of times of the cycle repetitions increased, more stabilized thickness may be achieved.

In cases where each of the gas flow rate increasing/decreasing steps and the gas supply/shut-off steps is performed for less than 5 seconds, a thickness variation in the gas diffusion layer due to an increase/decrease of pressure may not sufficiently take place. Further, in cases where each of the above steps lasts over 60 seconds, a time required for the pre-treatment process and an operation expense may be unnecessarily increased.

According to the embodiment of the present invention, the gas diffusion layer is subjected to the pre-treatment process while the stack is preliminary clamped. The clamping pressure variation that is caused by a variation in thickness of the gas diffusion layer during the pre-treatment process is corrected before the main clamping process is performed. Accordingly, irreversible variation in thickness, lowering in clamping pressure, and creation of a tiny gap may be minimized, and a contact resistance between the bipolar plate and the gas diffusion layer and between the MEA and the gas diffusion layer may be minimized. Further, since the surface pressure may be evenly distributed in the stack, the performance of the stack is improved compared to those achievable by existing clamping methods.

The flow rate variation cycle is executed in the stack to induce a variation in clamping pressure between components included in the stack and a variation in the thickness of the gas diffusion layer that may occur due to a variation in flow rate in the pre-treatment process. Accordingly, any cycle that directly increases or decreases the clamping pressure, other than the flow rate variation cycle, may be performed to cause the variation in clamping pressure and the variation in thickness of the gas diffusion layer.

In the second embodiment, the preliminary clamping process occurs after the stacking (S11) is performed as in the first embodiment (S12). In the pre-treatment cycle, however, the gas flow rate variation cycle is replaced by a clamping pressure variation cycle (S14).

During the clamping pressure variation cycle, a process is repeated a predetermined number of times that pressurizes the stack at a predetermined pressure using the pressure tool so that a tiny pressure is further exerted to the gas diffusion layer through the bipolar plate, and then releases the pressure.

At a first cycle, the predetermined pressure is exerted to the stack to cause a change in clamping pressure of the stack, and is then released. Thereafter, the pressure tool is operated so that pressurization of the same pressure and pressure release are repeated for each cycle.

In the above process, the pressure tool pressurizes both end plates to change the clamping pressure. While the end plates are pressurized and released, the gas diffusion layer is pressurized and released through each bipolar plate, so that the thickness of the gas diffusion layer is changed.

Through the repetitive pressurization and release of the same pressure, the thickness of the gas diffusion layer is gradually reduced from a portion contacting a land portion of the bipolar plate, and after a predetermined number of cycles, the stack goes into the stable state without a further change in thickness, as can be achieved by varying the flow rate at a predetermined number of times.

During the clamping pressure variation cycle, the number of cycles may be two or three as in the first embodiment. Considering that the gas diffusion layer has different physical properties (depending on the manufacturers), at least 10 or more cycles may be repeated. Further, the time required of maintaining each of the gas flow rate increasing/decreasing steps and the gas supply/shut-off steps may be 5 seconds to 60 minutes.

After the pre-treatment process that repeatedly increases and decreases the clamping pressure by additionally exerting or releasing a pressure, the thickness of the gas diffusion layer is reduced to some degree, so that the clamping pressure measured when the pressure is released becomes lower than the pressure measured right after the preliminary clamping process and before the pre-treatment process, and no gap is created between the gas diffusion layer and the bipolar plate.

When the thickness of the gas diffusion layer is stabilized, the clamping pressure variation is subjected to correction over the entire stack to get rid of a tiny gap that may occur when the clamping pressure is lowered. Then, the main clamping process (S15) and the stack activation process (S16) are sequentially conducted, thus completing clamping and assembling of the stack.

The correction of the clamping pressure variation may be conducted in the same way as in the first embodiment.

By the above method that additionally deforms the gas diffusion layer through the gas flow rate variation cycle or clamping pressure variation cycle to stabilize the thickness of the gas diffusion layer before the stack is subjected to the main clamping process, a variation in thickness of the gas diffusion layer that may occur at an early stage of stack operation may be minimized as shown in FIGS. 8 and 9. Accordingly, it can be possible to solve various problems that may occur due to the variation in thickness of the gas diffusion layer while the stack operates.

In general, after the main clamping process for the stack is complete, air (oxygen)/hydrogen are injected into the stack to activate performance of the stack. Such a stack activation process commonly includes a process of generating electric power by supply of a reaction gas.

Accordingly, if the stack activation process performs the stack operation with required maximum/minimum flow rates, the above pre-treatment process is optional.

Specifically, as shown in FIG. 6, after the cells are stacked and the end plates are joined (S21), the stack is preliminarily clamped (S22). Then, the stack activation process is first performed (S23). When the thickness of the gas diffusion layer is stabilized, the clamping pressure variation may be corrected over the overall stack and then the main clamping process for the stack may be performed (S24).

The third embodiment may include a process of increasing or decreasing the flow rate of reaction gas, such as hydrogen and oxygen (air), supplied into the stack to activate the stack similarly to the gas flow rate variation cycle according to the first embodiment.

At this time, before being supplied into the stack, the reaction gas may be changed to have a maximum flow rate or minimum flow rate that is required during the stack operation, and such a process may be repeated a number of cycles.

If the process of increasing and decreasing the flow rate of the supplied reaction gas is repeated during the activation process, the gas diffusion layer does not experience a further thickness variation as in the first embodiment, which is referred to as “stabilized state”.

Under the stabilized state, a tiny gap is created between the gas diffusion layer and the bipolar plate and the clamping pressure of the stack is lowered compared to immediately after the stack is preliminarily clamped.

Before the main clamping process, the clamping pressure variation is corrected over the entire stack to get rid of the tiny gap that has been generated while the clamping pressure is lowered. The correction and main clamping process are performed in the same manner as in the first embodiment.

An existing gas diffusion layer was evaluated in the manner as shown in FIG. 7 to establish a relationship between a change in flow rate of a reaction gas passing through the gas diffusion layer and a change in clamping pressure according to the change in flow rate of the reaction gas, and to apply the established relationship to a process of actually clamping the stack.

Since a fuel cell stack needs to maintain an airtight seal of a cathode/anode and a cooling water flow field, a process of clamping the stack is performed at more than a predetermined pressure that guarantees the airtight seal upon manufacture of the stack. In general, a fastener, such as a clamping band or a clamping rod (long bolt), is used for stack clamping. In this case, after the stack clamping is complete, the thickness displacement (stack size) remains unchanged.

The gas diffusion layer, which is a component of the stack, is made of a porous carbon support. The thickness of the gas diffusion layer is changed depending on a clamping pressure. The thickness of the gas diffusion layer is determined based on the clamping pressure measured right after the stack clamping is done.

Further, the fuel cell stack is supplied with air (oxygen) and hydrogen variably depending on electric power required for the stack. As the supply of the reaction gas into the stack increases/decreases, the stack clamping pressure is slightly changed.

However, it is not easy to directly measure a tiny pressure change in the inside of the stack. Accordingly, a device shown in FIG. 7 is used to measure it.

While the gas diffusion layer 2 is pressurized by a pressure tool 3, a position displacement of a fastener (for example, load cell 1) remained unchanged to make the thickness of the gas diffusion layer 2 constant.

Thereafter, the clamping pressure was measured while a flow rate of a gas passing through the gas diffusion layer was changed, and a result thereof was shown in FIG. 8.

It can be seen from the above experiment that as the flow rate of the gas passing through the gas diffusion layer having a constant thickness displacement is increased, the clamping pressure exerted to the load cell is increased correspondingly. It can be expected that this is also true for inside of the actual stack.

Since a reaction gas actually introduced into the stack is supplied on the order of about 1.5-3.0 based on stoichiometry ratio, a flow rate supplied to a cathode is different from a flow rate supplied to an anode, and a change in clamping pressure due to a gas flow rate variation occurring during the stack operation occurs differently for each of the cathode and anode.

As described above, a stack clamping pressure variation due to a reaction gas flow rate variation in the stack causes an additional thickness deformation of the gas diffusion layer. It can lead to an additional thickness variation in the gas diffusion layer to repeat a cycle of pressurizing the gas diffusion layer preliminary clamped under a predetermined pressure by a clamping pressure that maybe generated by a gas flow rate variation and releasing the pressure.

This phenomenon becomes distinct during early three to five cycles, and thereafter, the thickness of the gas diffusion layer is stabilized.

As can be seen from the above experiment, a further thickness deformation of the gas diffusion layer after the completion of the stack clamping may give rise to an increase in contact resistance between the bipolar plate and gas diffusion layer and between the MEA and gas diffusion layer, which is a main cause of a lowering in stack performance. To avoid this problem, a predetermined maximum/minimum flow rate cycle for the reaction gas, which is required by a system, is repeated several times with the fuel cell stack preliminary clamped to stabilize the thickness of the gas diffusion layer. Then, the overall thickness variation in the stack is corrected, thus completing the stack clamping.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

1. A method of clamping a fuel cell stack, comprising:
setting and fastening a fastener to the stack so that a clamping pressure exerted to the stack by a pressure tool is maintained, wherein the stack includes a plurality of unit cells stacked on one another and end plates joined on the stacked unit cells;
performing a stack pre-treatment step by a gas flow rate variation cycle or a clamping pressure variation cycle, wherein the gas flow rate variation cycle repeatedly changes a flow rate of a gas supplied to an anode and a cathode included in the preliminarily clamped stack, wherein the clamping pressure variation cycle repeatedly increases and decreases the clamping pressure by pressurization and pressure release of the preliminarily clamped stack using the pressure tool; and
correcting a variation in clamping pressure occurring due to a variation in thickness of a gas diffusion layer to mainly clamp the stack after the stack pre-treatment step.

2. The method of claim 1, wherein
the gas flow rate variation cycle performs flow rate increasing/decreasing steps of the gas supplied to the anode and the cathode, included in the preliminarily clamped stack or gas supply/shut-off steps, to repeatedly cause a flow rate variation.

3. The method of claim 2, wherein
in the gas flow rate variation cycle, a flow rate of the gas supplied during the gas flow rate increasing step or a flow rate of the gas supplied during the gas supply step is set to a predetermined maximum flow rate of a reaction gas required for stack operation, and a flow rate of the gas supplied during the gas flow rate decreasing step is set to a predetermined minimum flow rate of the reaction gas required for stack operation.

4. The method of claim 2, wherein
the gas flow rate variation cycle repeats two or three basic cycles, and for each basic cycle, each of the gas flow rate increasing/decreasing steps and the gas supply/shut-off steps lasts about 5 seconds to about 60 minutes.

5. The method of claim 2, wherein
the gas flow rate variation cycle repeats at least ten basic cycles, and for each basic cycle, each of the gas flow rate increasing/decreasing steps and the gas supply/shut-off steps lasts about 5 seconds to about 60 minutes.

6. The method of claim 1, wherein
the gas is air or an inert gas.

7. The method of claim 1, wherein
the gas flow rate variation cycle is performed by supplying a reaction gas during a stack activation process after the stack preliminary clamping step, and the stack main clamping step is performed after the stack activation process.

8. The method of claim 1, wherein
a relative humidity of the gas is in a range between about 20% to about 100%, and a temperature of the gas is in a range between about 0° C. to about 95° C.

9. The method of claim 1, wherein
the clamping pressure variation cycle repeatedly pressurizes and depressurizes the end plates by a pressure tool so that an additional pressure is exerted to the gas diffusion layer through a bipolar plate.

10. The method of claim 1, wherein
the stack main clamping step includes exerting the same pressure as the pressure exerted during the stack preliminary clamping step to the stack having the gas diffusion layer, whose thickness has been reduced after the stack pre-treatment step by the pressure tool to correct a decrease in the clamping pressure, and resetting and fastening the fastener so that the clamping pressure is maintained.

11. The method of claim 1, further comprising:
activating the stack after the stack main clamping step to complete clamping and assembly of the stack.

12. The method of claim 2, wherein
a relative humidity of the gas is in a range between about 20% to about 100%, and a temperature of the gas is in a range between about 0° C. to about 95° C.

13. The method of claim 6, wherein
a relative humidity of the gas is in a range between about 20% to about 100%, and a temperature of the gas is in a range between about 0° C. to about 95° C.

14. The method of claim 7, wherein
a relative humidity of the gas is in a range between about 20% to about 100%, and a temperature of the gas is in a range between about 0° C. to about 95° C.
